(19) United States
(12) Patent Application Publication
(10) Pub. No.: US 2006/0251992 A1
(43) Pub. Date: Nov. 9, 2006

(54) Smooth heat sink or reflector layer for optical record carrier

(76) Inventors: Hans Willem Van Kesteren, Eindhoven (NL); Coen Adrianus Verschuren, Eindhoven (NL); Gavin Nicholas Phillips, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,229

(22) PCT Filed: Mar. 15, 2004
(86) PCT No.: PCT/IB04/50259

§ 371 Date: Sep. 12, 2005

(30) Foreign Application Priority Data
Mar. 18, 2003 (EP) 03100693.5

(51) Int. Cl. G11B 7/24

(52) U.S. Cl. 430/270.13; 430/945; 369/275.2; 369/275.5; 428/64.1

(57) ABSTRACT

The present invention relates to an optical record carrier with layer stack comprising a reflector or heat sink layer, a recording layer, and at least one ruthenium (Ru) interlayer arranged between said reflector or heat sink layer and said recording layer. Furthermore, the present invention relates to a method of manufacturing such a record carrier. In particular, Ru thin films may form a top or cover layer, a bottom or seed layer, or may be interleaved within reflector or heat sink layers. The Ru layer(s) lead to a modified microstructure and/or smoothness of the recording stack, so that the carrier-to-noise level can be improved during readout.

The present invention relates to an optical record carrier, such as an optical disc, with a layer stack comprising a recording layer and a reflector or heat sink layer.

In optical recording, data is represented as a magnetic domain in a magneto-optical (MO) recording medium or as an amorphous mark in a phase-change (PC) recording medium.

Magneto-optical (MO) recording media, such as record carriers or discs, are usually based on an amorphous terbium-iron-cobalt (TbFeCo) magnetic alloy. This material belongs to a class of materials known as rare earth-transition metal (RE-TM) alloys. The writing and erasure of data on MO record carriers relies on the heat generated by a focused laser beam to raise the temperature of the material to the vicinity of its Curie point. A small externally applied magnetic field can then orient the direction of magnetization of the heated spot after the laser has been turned off and the material has cooled down. Writing of the information can be achieved by modulating the external magnetic field according to the data to be written and simultaneously pulsing the laser at the bitstream frequency. This method is known as the laser pulsed magnetic field modulation (LP-MFM) recording scheme. Alternatively, a reverse-magnetizing DC magnetic field can be applied in combination with a continuous laser beam to erase a region of interest in a first step, while subsequently the field is switched back and the laser power is modulated to record the information along the track. This is known as the laser power modulation recording or light intensity modulation (LIM) scheme.

The MO recording media rotate the polarization vector of the incident laser beam upon reflection. This is known as the polar magneto-optical Kerr effect. The sense of polarization rotation is dependent on the state of magnetization of the medium. Thus, when the magnetization is pointing up, e.g., the polarization rotation is clockwise, whereas downward magnetized domains rotate the polarization counter-clockwise. The polar Kerr effect provides a mechanism for readout in MO disc data storage. Readout and writing in optical disc drives are typically performed with the same laser.

The storage layer of MO media are usually amorphous. The lack of crystallinity in these media makes their reflectivity extremely uniform, thereby reducing the fluctuations of the read signal. This amounts to very low levels of noise during readout, which ultimately helps to increase the achievable data storage densities. In general, the larger the available signal-to-noise ratio from a given medium, the higher will be the achievable data packing density in that medium. Other sources of readout noise are the thermal noise of the electronic circuitry, shot noise from the photo detectors, and laser noise. The method of MO readout is a differential method, whereby the signal is split between two photo detectors and the outputs of the two are then subtracted from each other to yield the final signal. The subtraction eliminates many of the common mode sources of noise, but of the noises that remains at the end, the media noise is still the dominant component.

In phase-change (PC) recording, small regions of the recording medium are turned into amorphous marks by raising the local temperature above the melting point and allowing a rapid cooling down, or quenching. The reflectivity of the amorphous mark is different from that of the polycrystalline background and, therefore, a signal is developed during readout. Erasure is achieved by using a laser pulse of an intermediate power level, i.e., between the read and write powers. If sufficient time is allowed for the laser spot to dwell on the amorphous mark, the mark will become crystalline once again, i.e., due to an annealing process.

Increasing storage density is one of the main objectives of data storage systems manufacturers, because it results in lower cost per data unit for the customer, allows for a greater storage capacity within a standard drive geometry, and can lead to new smaller drive formats. High data storage density and low cost currently drive the highly competitive data storage business. One technique for increasing the storage density of optical recording media is to reduce the spot size of the light beam incident on the recording medium. The spot size of the focused light spot used for reading the storage media must be reduced to read back smaller marks. Thin film performance and engineering issues emerge both as a result of the reduced area of the focused light spot and as a result of the methods used for achieving the reduced light spot.

One problem that results from using a smaller spot size is excessive heating of the media Because the minimum laser read power is limited by system considerations such as laser and detector shot noise, reducing the spot size leads to larger light intensity (power density) at the media surface. Increasing the light power density at the media surface becomes a critical problem when the stored data is corrupted at the higher temperatures associated with higher power densities.

Methods for achieving a smaller spot size include both the use of an optical system with a high numerical aperture (NA), and the use of near field optical techniques. For optical recording with a high-NA focusing objective (NA>0.7) usually an air-incident or cover-layer incident recording configuration is chosen. In such systems, the reading laser beam is incident on the thin film side of the optical storage disc. Thus, the thin films in the stack on the disc are in reverse sequence from those in conventional substrate-incident recording media Reversing the sequence of layers in the stack has implications for several aspects of the media performance. One important aspect is the magnetic field sensitivity of the recording layer in the recording medium. The field sensitivity of the recording layer depends critically on the surface conditions, especially roughness, of the layer onto which it is deposited. When the layer sequence is reversed using conventional stack materials and processes, the field sensitivity can be degraded, i.e. less sensitivity is observed during writing.

Especially in these reversed stack media, where the recording layer is on top of several base layers, the micro-structure of the base layers is very important. An Aluminum alloy (AlCr, AlTi) has been widely applied as a heat sink or reflector layer in PC media as well as MO media However, other heat sink or reflector materials, such as Ag alloys are currently studied for cover-layer incident recording because they form a smoother base layer.

To obtain low noise levels during readout it is essential to use layers in the recording stack on the disc with a surface roughness that is as low as possible. For domain expansion media this has become even more relevant because good expansion signals from MAMMOS (Magnetic AMplifying Magneto-Optical System) and especially DWDD (Domain Wall Displacement Detection) media can only be obtained when the expansion is not hindered by roughness induced pinning of the domain wall. This puts high requirements not only on the substrate quality but also on the smoothness of the layers in the recording stack. In contrast to substrate-incident media where the heat sink or reflector layer is on top, the heat sink or reflector layer is used as a base layer in air-incident and cover-layer incident media. Therefore, a rough heat sink or reflector layer will most likely lead to an increased roughness of the actual recording and readout layers on top.

It is therefore an object of the present invention to provide an optical record carrier with improved smoothness of the layers in the recording stack.

This object is achieved by an optical record carrier as claimed in claim 1 and by a manufacturing method as claimed in claim 10.

Accordingly, by introducing the ruthenium (Ru) interlayer into the recording stack, the microstructure and/or smoothness can be modified within the recording stack. In particular, the surface of the heat sink or reflector layer can be smoothed. The application of a smooth heat sink layer thus leads to an important improvement especially of cover-layer incident or air-incident domain-expansion media Thereby, good domain expansion performance can be obtained. This improves the disc recording performance by reducing the disc noise level. Besides the reduced disc noise level, also the signal level increases.

The Ru interlayer may be arranged on top of the reflector or heat sink layer. In particular, the Ru interlayer may be covered by another layer of heat sink material.

As an alternative, the at least one Ru interlayer may be arranged in a multilayer structure comprising first layers of Ru and second layers of heat sink material.

The heat sink material may be aluminum (Al), silver (Ag), copper (Cu) or gold (Au) or alloys based on these materials like AlCr and AlTi.

The optical record carrier may be a PC recording medium or an MO recording medium. Furthermore, the optical record carrier may be an air-incident or a cover-layer incident recording medium.

In the following, preferred embodiments of the present invention will be described in greater detail with reference to the accompanying drawings, in which:

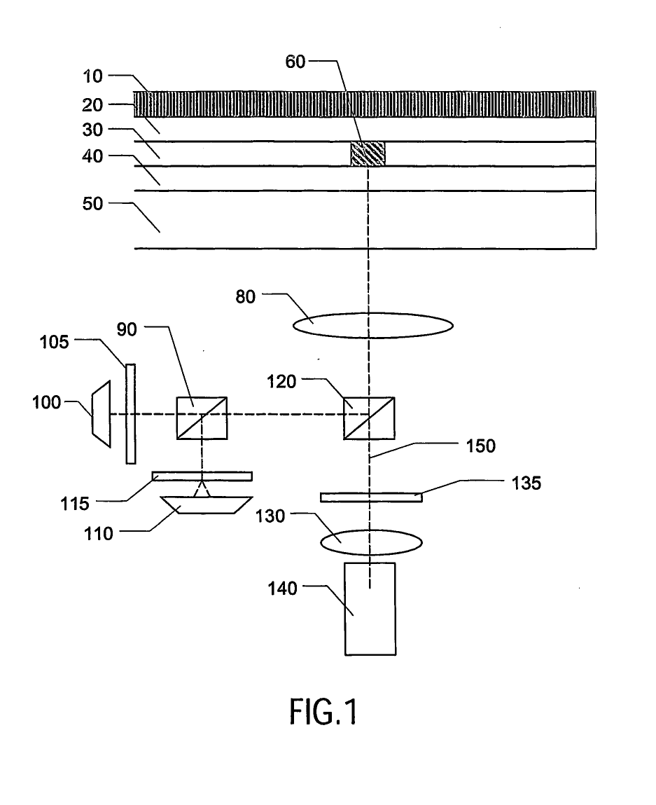

FIG. 1 shows a schematic side view of a cover-layer incident recording stack of an optical recording medium with heat sink or reflector layer, in which the present invention can be implemented;

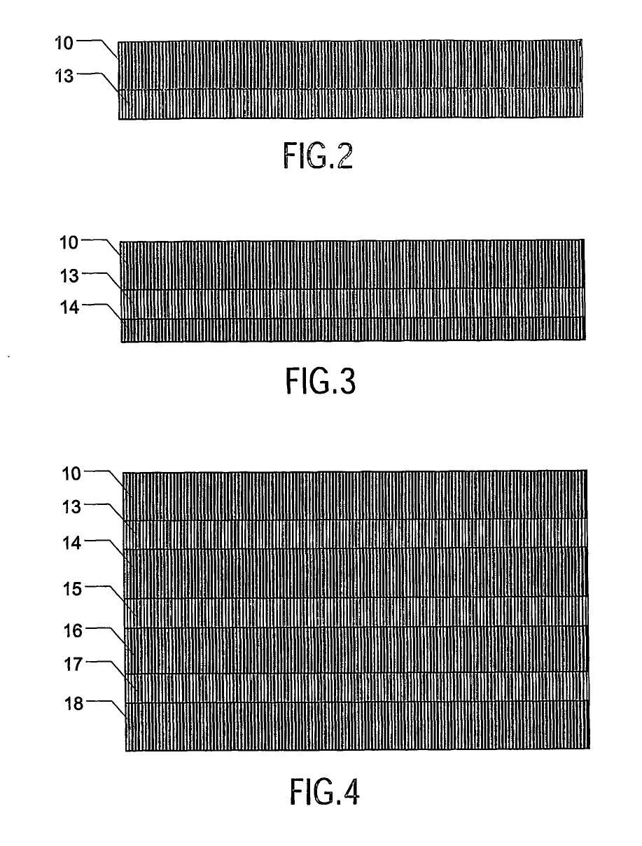

FIG. 2 shows a schematic side view of a heat sink or reflector layer with a Ru layer according to a first preferred embodiment;

FIG. 3 shows a schematic side view of a heat sink or reflector layer with a Ru layer covered by an additional heat sink layer, according to a second preferred embodiment, and

FIG. 4 shows a schematic side view of a heat sink or reflector layer composed of a multilayer structure of heat sink or reflector layers and Ru layers, according to the third preferred embodiment.

The preferred embodiments will now be described based on a cover-layer incident MO recording system, as shown in FIG. 1.

According to FIG. 1, the recording system is arranged to write and read data from the cover-layer incident storage medium, e.g. an optical disc. The recording system comprises an optical unit 140 with a laser device for generating a laser beam 150, a condensing lens 130, a beamshaper 135, beam splitters 90 and 120, an objective lens 80, a Wollaston 115 and MO signal detector 110 and an optical element 105 to generate appropriate spots on the tracking and focussing detector 110.

In operation, the optical unit 140 directs the laser beam 150 through the condensing lens 130 and beamshaping optics 135. The laser beam 150 than passes through a first beam splitter 120 and is focused by the objective lens 80. The beam is transmitted into the recording medium and focused to a point where a domain 60 shall be formed, thereby heating the volume of the domain 60 to the right temperature. A magnetic field source (not shown) provides a magnetic field which orients the magnetic material of the domain 60 as it cools, thereby writing a bit.

The laser device preferably also operates at a lower intensity for reading the optical disc. The light of the laser beam 150 is reflected back from the optical disc towards the first beam splitter 120. Upon reflection from the optical disc, the polarization of the light is rotated clockwise or counter clockwise depending on the magnetic orientation of the recording medium. The light is then reflected by the first beam splitter 120 towards a second beam splitter 90, where the beam is divided toward the MO signal detector 110 and the tracking and focussing detector 100. The Wollaston 115 splits the beam in two beams with an intensity difference that depends on the direction of polarization and, therefore the information state of the domain 60 can be detected with the differential MO detector 110. Appropriate spots for tracking and focussing by detector 100 are generated by the optical component 105.

The cover-incident optical disc comprises the following layers in order of application: A reflector or heat sink layer 10, a first dielectric layer 20, a MO layer 30, a second dielectric layer 40 and a cover layer 50. The reflector or heat sink layer 10 serves to reflect the laser light from the optical disc and/or to remove heat generated in the layers of the optical disc during reading and writing operations. The first dielectric layer 20 is sometimes left out to improve the cooling behavior or improve the magneto-optical response. The MO layer 30 can incorporate besides the storage layer several other RE-TM layers to allow, for instance, domain expansion readout.

Light emitted from the optical unit 140 enters and exits the recording medium on the side opposite from the reflector or heat sink layer 10. The reflector or heat sink layer 10 is usually made of Al or an Al alloy and is typically between about 20 nm and about 100 nm thick. The reflector or heat sink layer 10 is usually deposited by one of many well known vapor deposition techniques such as sputtering or thermal evaporation.

It has been observed that the coercivity of a TbFeCo layer is modified when a Ru interlayer is applied below the TbFeCo layer. Due to the fact that the coercivity is related to microstructure and smoothness of the layer, Ru is an interesting material to modify the microstructure and/or the smoothness in other parts of the recording stack as well. The most interesting layer in that respect is the heat sink or reflector layer 10. Although it is known that it is difficult to make very smooth Al layers, Al is often used for this reflector or heat sink layer 10.

According to the preferred embodiments, at least one thin film of Ru is used to increase the signal-to-noise ratio (SNR) of the air-incident or cover-layer incident optical disc by modifying the roughness of the heat sink or reflector layer 10. The at least one Ru thin film may form at least one of a top or cover layer, a bottom or seed layer, or layers interleaved with reflector or heat sink layers, as described in the following on the basis of the first to third preferred embodiments. For obtaining the highest SNR and lowest transition jitter an optimum exists for the roughness of the base layers applied before the storage layer. A smooth base layer will reduce the disk noise and suppress subdomain formation during recording and will therefore reduce the noise level and increase the signal level while on the other hand some roughness might be required to pin down the domain transitions and obtain a low transition jitter. By combining the heatsink layer in an appropriate way with a Ru interlayer this optimum can be reached.

FIG. 2 shows a layer stack of a modified reflector or heat sink layer arrangement according to the first preferred embodiment. A thin Ru layer 13 is applied on top of the thicker reflector or heat sink layer 10 which may be an Al layer. In the first preferred embodiment, the reflector or heat sink layer may have a thickness of at least 20 nm and the Ru layer 13 may have a thickness of about 1nm. The Ru layer 13 serves to smoothen the surface of the modified reflector or heat sink layer arrangement

FIG. 3 shows a schematic side view of a layer stack of a modified reflector or heat sink layer arrangement according to the second preferred embodiment. In the first preferred embodiment, the different optical properties of Ru and Al might make it necessary to adjust the whole recording stack slightly. This can be prevented if the thin Ru layer 13 is covered by another reflector or thin heat sink layer 14 also made of Al. In that case, there will be less influence on the optical properties, however this may be at the expense of the optimum smoothness not being achieved. As an example, the reflector or heat sink layer may have a thickness of at least 20 nm and the Ru layer 13 may have a thickness of about 1 nm, and the other reflector or heat sink layer 14 may have a thickness of about 5 nm.

FIG. 4 shows a layer stack of a modified reflector or heat sink layer arrangement according to the third preferred embodiment In the third preferred embodiment, a multilayer structure of AlTi alloy layers 10, 14, 16 and 18 and Ru layers 13, 15 and 17 is used. The multilayer structure can be optimized, e.g. in size and structure, such that a good comprise is obtained between optical, thermal and micro structural or smoothness requirements.

It is noted that the modified reflector or heat sink layer arrangements according to the first to third preferred embodiments are intended to replace the single reflector or heat sink layer 10 of FIG. 1. Instead of Al, other heat sink materials such as Ag, Cu and Au may be used in combination with Ru in either multilayer or alloy form. The formation of the layers of the proposed modified reflector or heat sink layer arrangements may be performed based on one of the deposition techniques described above.

Furthermore, the reflector or heat sink layer(s) with their Ru layer(s) can be applied in PC as well as MO optical media. The application of the modified smooth reflector or heat sink layer is very important for cover-layer incident domain-expansion media due to the fact that good domain expansion is only obtained on smooth substrates in combination with smooth base layers.

The effect of the Ru interlayer has been verified experimentally by measuring the disc noise level N and the carrier level C and determining the carrier-to-noise ratio CNR for a TbFeCo recording layer in a MO cover-layer incident disc with a 25 nm TbFeCo layer, 40 nm dielectric layer of SiN, and different Al/Ru reflector or heat sink layers. The results are shown below in table 1, wherein the first or upper row corresponds to a conventional reflector or heat sink layer made solely of Al.

TABLE 1

| Heat sink material | C (dBm) | N (dBm) | CNR (dB) |
|---|---|---|---|
| 75 nm Al | −37.2 | −83.6 | 46.4 |
| 75 nm Al/1 nm Ru | −36.4 | −85.6 | 49.2 |
| 69 nm Al/1 nm Ru/5 nm Al | −35.4 | −84.7 | 49.3 |

It is clear from the measurements that the Ru layers indeed improve the disc recording performance by reducing the disc noise level N which is related to the smoothness. According to the second row of table 1, which corresponds to the first preferred embodiment, the noise level N is reduced by 2 dB and the carrier level C is increased by 0.8 dB, leading to an increase in the CNR by 2.8 dB. According to the third row of table 1, which corresponds to the second preferred embodiment, the noise level N is reduced by 1.1 dB and the carrier level C is increased by 1.8 dB, leading to an increase in the CNR by 2.9 dB. Thus, besides the reduction of the disc noise level N, also the carrier level C is increased. This might be related to the improved magnetic properties of the TbFeCo recording layer arranged on the smooth base layers, giving less tendency to sub-domain formation and sharper domain transitions.

It is noted that the present invention is not restricted to the above preferred embodiments but the reflector or heat sink layer(s) and the Ru layer(s) can have any suitable thickness and may be used in any optical storage media, especially air-incident or cover-layer incident media, where the reflector or heat sink layer is used as a base layer. Moreover, the Ru layer may be used as a cover layer, a seed layer or an interleaved layer for any other layer of the recording stack to thereby smoothen the base layer of the recording stack. The preferred embodiments may thus vary within the scope of the attached claims.

1. An optical record carrier for cover-layer or air-incident recording with a layer stack comprising:
a) a heat sink layer (10);
b) a recording layer (30); and
c) at least one ruthenium interlayer (13; 13, 15, 17) arranged at the heat sink layer side of said recording layer (30).

2. A record carrier according to claim 1, wherein said ruthenium interlayer (13) is arranged between said heat sink layer (10) and said recording layer (30).

3. A record carrier according to claim 2, wherein the thickness of said ruthenium layer (13) is about 1 nm, and the thickness of said reflector or heat sink layer (10) is larger than 20 nm.

4. A record carrier according to claim 2, wherein said ruthenium interlayer (13) is covered by another layer (14) of heat sink material.

5. A record carrier according to claim 4, wherein said ruthenium layer has a thickness of about 1 nm, said reflector or heat sink layer (13) has a thickness of at least 20 nm, and said other layer (14) has a thickness of about 5 nm.

6. A record carrier according to claim 1, wherein said at least one ruthenium interlayer is arranged in a multi-layer structure comprising first layers (13, 15, 17) of ruthenium and second layers (10, 14, 16, 18) of heat sink material.

7. A record carrier according to claim 1, wherein the heat sink material is Al, Ag, Cu or Au or any combination or alloy based on Al, Ag, Cu or Au.

8. A record carrier according to claim 1, wherein said optical record carrier is a phase-change recording medium or a magneto-optical recording medium.

9. A record carrier according claim 1, wherein said optical record carrier is a magneto-optical super-resolution or domain-expansion medium.

10. A method of manufacturing an optical record carrier according to claim 1, said method comprising the step of forming at least one ruthenium interlayer (13; 13, 15, 17) as an intermediate layer within said layer stack.

11. A method according to claim 10, wherein said method comprises the step of forming said at least one ruthenium interlayer (13) as a cover layer or a seed layer of said reflector or heat sink layer (10).

12. A method according to claim 10, wherein said method comprises the step of forming said at least one ruthenium layer (13, 15, 17) as a plurality of layers interleaved with a plurality of reflector or heat sink layers (10, 14, 16, 18).

13. A method according to claim 10, wherein said ruthenium layer is applied on said optical record carrier before said heat sink layer is applied.
